(19) United States
(12) Patent Application Publication
(10) Pub. No.: US 2014/0372918 A1
(43) Pub. Date: Dec. 18, 2014

(54) SYSTEM AND METHOD FOR ADJUSTING POSITION OF USER INTERFACE OF APPLICATION

(71) Applicants: FU TAI HUA INDUSTRY (SHENZHEN) CO., LTD., Shenzhen (CN); HON HAI PRECISION INDUSTRY CO., LTD., New Taipei (TW)

(72) Inventor: PENG WANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/252,283

(22) Filed: Apr. 14, 2014

(30) Foreign Application Priority Data
Jun. 17, 2013 (CN) 2013102386223

(51) Int. Cl. G06F 3/0484

(52) U.S. Cl. CPC G06F 3/0484
USPC 715/765

(57) ABSTRACT

A system for adjusting a position of a user interface of applications running in an electronic device is provided. The system includes a first determining module, an acquiring module, a second determining module, a dividing module, and an adjusting module. The first determining module determines the applications running in the electronic device, and the priority of each determined application. The acquiring module acquires the predetermined frame of the user interface of the application. The second determining module determines a first area in a display screen of the electronic device according to the acquired predetermined frame. The dividing module determines a remaining area, and divides the remaining area into a number of sub-areas according to a predetermined division rule. The adjusting module adjusts the positions of the user interfaces of remaining applications to the different sub-areas.

### FIELD

The present disclosure relates to systems, and particularly to a system and a method for adjusting a position of user interface of applications running in an electronic device.

### BACKGROUND

In prior art, an electronic device usually includes a number of installed applications. Each application corresponds to a user interface. When the applications runs, the number of user interfaces will be overlapped together on the electronic device, it is not convenient for the user to view.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of a system for adjusting a position of a user interface of applications running in an electronic device in accordance with an exemplary embodiment.

FIGS. 2-3 illustrate example screens having a position of the user interfaces of the applications.

FIG. 4 is a flowchart of a method of adjusting a position of a user interface of the applications implemented by the system of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.” The references “a plurality of” and “a number of” mean “at least two.”

Embodiments of the present disclosure will be described with reference to the accompanying drawings.

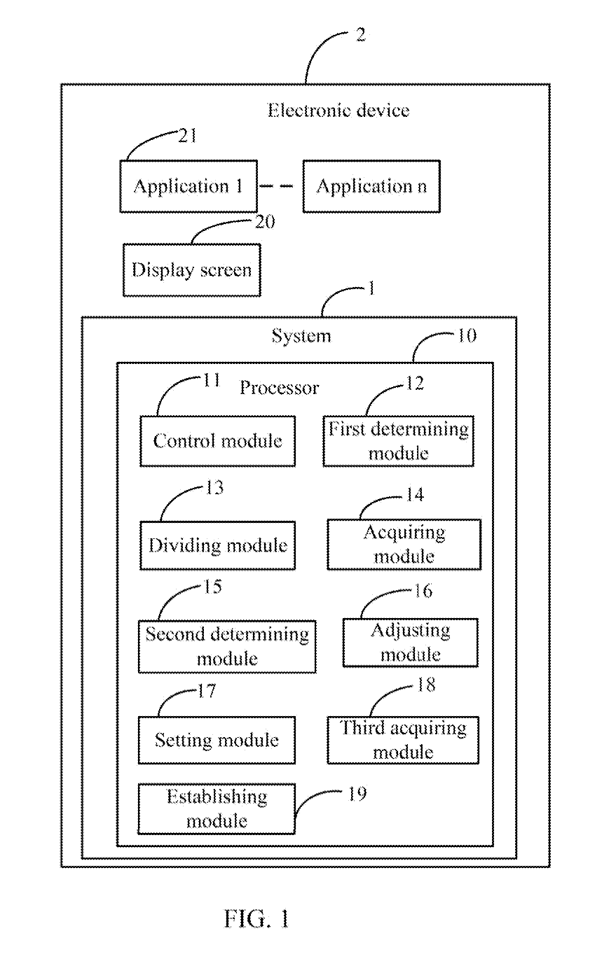

FIG. 1 illustrates a system 1 for adjusting a position of a user interface of the applications running in an electronic device 2. The electronic device 2 includes a display screen 20, a processor 10, and a number of installed applications 21. Each application 21 corresponds to a user interface and is assigned a priority. Each user interface includes a predetermined frame. Each predetermined frame can have a unique pixel value for identification. In one embodiment, the shape of the user interface of each application is a rectangular frame.

The processor 10 includes a control module 11, a first determining module 12, an acquiring module 14, a second determining module 15, a dividing module 13, and an adjusting module 16 which are collection of software instructions executed by the processor 10.

The control module 11 controls the electronic device 2 to enter an automatic adjusting mode in response to a user operation. The first determining module 12 determines the applications 21 running in the electronic device 2 real time, and acquires the priority of each determined application 21 when the electronic device 2 is in the automatic adjusting mode. The acquiring module 14 acquires the predetermined frame of the user interface of the application whose priority is the highest. The second determining module 15 determines a first area where the user interface of the application having the highest priority is in the display screen 20 according to the acquired predetermined frame. In one embodiment, the second determining module 15 compares the pixel value of the acquired predetermined frame with the pixel values of the predetermined frames of the user interfaces displayed on the display screen, and determines an area whose pixel value is consistent with the pixel value of the acquired predetermined frame on the display screen 20, as the first area. The dividing module 13 determines a remaining area on the display screen, and divides the remaining area into a number of sub-areas according to a predetermined division rule. In one embodiment, the quantity of the sub-areas can be equal to or greater than a value which is obtained by reducing one from the quantity of the applications running in the electronic device 2. In one embodiment, the predetermined division rule can be defined to divide the remaining area into a number of sub-areas each having a same size. In other embodiments, the predetermined rule can be also defined to divide the remaining area into the number of sub-areas each having a different size. The adjusting module 16 adjusts the position of the user interfaces of the remaining applications whose priority is lower than the highest priority to the corresponding sub-areas on the display screen 20. The adjusting module 16 further adjusts a size of the predetermined frame of the user interfaces of the remaining applications to match a size of the different sub-areas, thereby avoiding that the number of user interfaces will be overlapped together on the display screen 20 of the electronic device 2. In one embodiment, when the size of the sub-areas are the same, the adjusting module 16 randomly assigns the positions of the user interfaces of the remaining applications to the different sub-areas, but when the size of the sub-areas are different, the adjusting module 16 assigns the positions of the user interfaces of the remaining applications to the different sub-areas according to the priority of the applications. For example, if the priority of a first application is higher than the priority of a second application, the adjusting module 16 assigns the position of the user interface of the first application to a first sub-area having a first size and assigns the position of the user interface of the second application to a second sub-area having a second size less than the first size of the first sub-area.

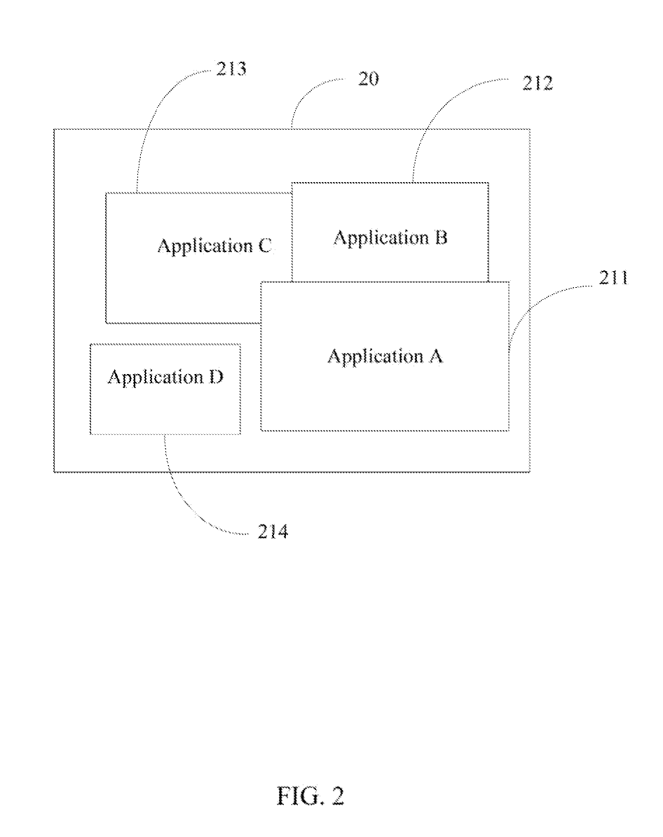

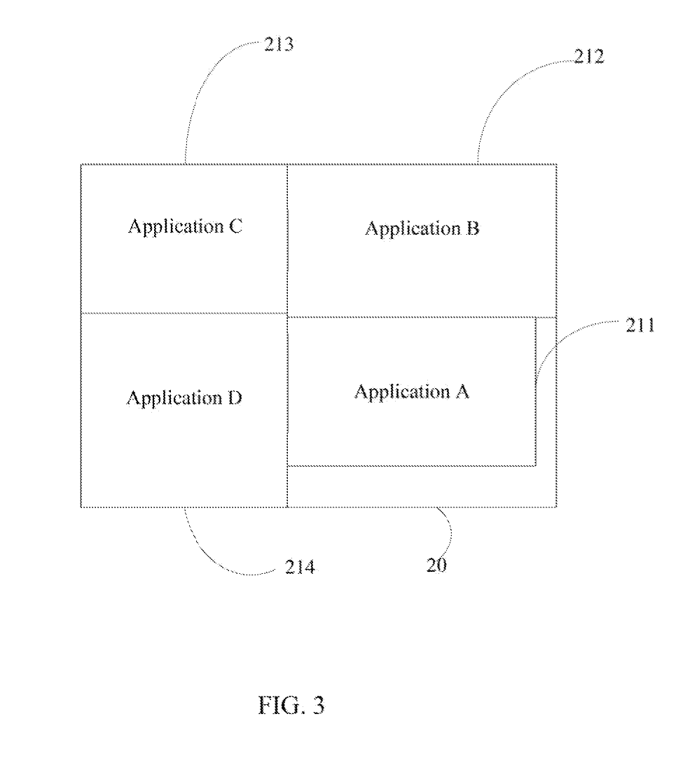

FIGS. 2-3 illustrate four applications, application A 211, application B 212, application C 213, and application D 214 running in the electronic device 2. The user interface of the application A 211, the application B 212, the application C 213 and the application D 214 are displayed on the display screen 20. As illustrated, the priority of the application A 211 is higher than that of the application D 214, the priority of the application D 214 is higher than that of the application B 212, and the priority of the application B 212 is higher than of the application C 213. When the first area for displaying the user interface of the application A 211 is determined, the remaining area is divided into the number of sub-areas each having the different size, because the priority of the application D 214 is higher than that of the application B 212, and the priority of the application B 212 is higher than the priority of the application C 213, the user interface of the application D 214 is displayed in the sub-area having the first size, the user interface of the application B 212 is displayed in the sub-area having the second size less than the first size, and the user interface of the application C 213 is displayed in the sub-area having a third size less than the second size.

As illustrated in FIG. 1, the processor 10 further includes a setting module 17, a third acquiring module 18, and an establishing module 19. The setting module 17 sets the priority of each application running in the electronic device 2 in response to the user operation. The third acquiring module 18 acquires sides of the user interface of each application, and determines the acquired sides as the predetermined frame of the user interface of each application. The establishing module 19 establishes relationships between the predetermined frames and the user interfaces of the applications.

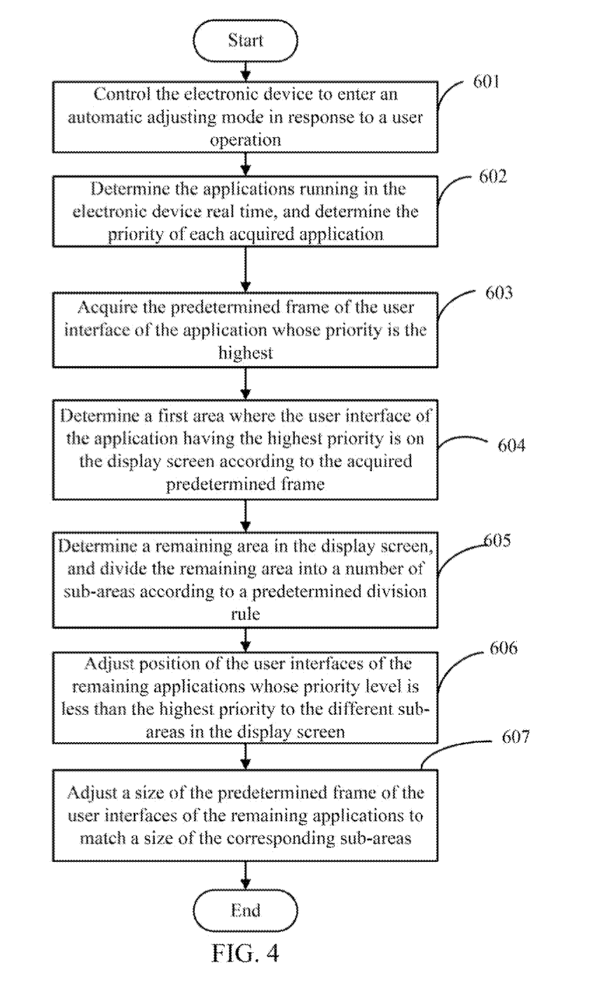

FIG. 4 is a flowchart of a method of adjusting a position of a user interface of applications implemented by the system of FIG. 1.

In 601, the control module controls the electronic device to enter an automatic adjusting mode in response to a user operation.

In 602, the first determining module determines the applications running in the electronic device real time, and acquires the priority of each determined application.

In 603, the acquiring module acquires the predetermined frame of the user interface of the application whose priority is the highest.

In 604, the second determining module determines a first area where the user interface of the application having the highest priority level is on the display screen according to the acquired predetermined frame.

In 605, the dividing module determines a remaining area on the display screen, and divides the remaining area into a number of sub-areas according to a predetermined division rule.

In 606, the adjusting module adjusts positions of the user interfaces of the remaining applications whose priority is lower than the highest priority to the different sub-areas in the display screen.

In 607, the adjusting module adjusts a size of the predetermined frame of the user interfaces of the remaining applications to match a size of the corresponding sub-areas.

The method further includes the following steps: the setting module sets the priority of the applications in response to the user operation, the third acquiring module acquires sides of the user interface of each application, and determines the acquired sides as the predetermined frame of the user interface of each application, and the establishing module establishes relationships between the predetermined frames and the user interfaces of the applications.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A system for adjusting a position of a user interface of applications running in an electronic device, each of the applications corresponding to a user interface and being assigned a priority, each user interface comprising a predetermined frame, the system comprising:
one or more processors; and
a plurality of modules to be executed by the one or more processors, wherein the plurality of modules comprises:
a first determining module configured to determine the applications running in the electronic device, and determine the priority of each determined application;
an acquiring module configured to acquire the predetermined frame of the user interface of the running application whose priority is the highest;
a second determining module configured to determine a first area where the user interface of the application having the highest priority is on a display screen of the electronic device according to the acquired predetermined frame;
a dividing module configured to determine a remaining area on the display screen, and divide the remaining area into a plurality of sub-areas according to a predetermined division rule;
an adjusting module configured to adjust the positions of the user interfaces of remaining applications whose priority is lower than the highest priority to the different sub-areas; and
the adjusting module further configured to adjust a size of the predetermined frame of the user interfaces of the remaining applications to match a size of the corresponding sub-areas.

2. The system as described in claim 1, wherein the plurality of modules further comprises:
a control module configured to control the electronic device to enter an automatic adjusting mode in response to a user operation, and
the first determining module configured to determine the applications running in the electronic device real time, and acquire the priority of each determined application when the electronic device is in the automatic adjusting mode.

3. The system as described in claim 1, wherein each predetermined frame has a unique pixel value for identification, the second determining module is configured to compare the pixel value of the acquired predetermined frame with the pixel values of the predetermined frames of the user interfaces displayed on the display screen, and determine an area whose pixel value is consistent with the pixel value of the acquired predetermined frame, as the first area.

4. The system as described in claim 1, wherein the adjusting module is configured to randomly assign the positions of the user interfaces of the remaining applications to the different sub-areas when size of the sub-area are same.

5. The system as described in claim 1, wherein the adjusting module is configured to assign the positions of the user interfaces of the remaining applications to the different sub-areas according to the priority level of the remaining applications when size of the sub-areas are different.

6. An electronic device for adjusting a position of a user interface of applications, each application corresponding to a user interface and being assigned a priority, each user interface comprising a predetermined frame, the electronic device comprising:
a display screen; and
a processor configured to determine the applications running in the electronic device, determine the priority of each determined application, acquire the predetermined frame of the user interface of the running application whose priority is the highest, determine a first area where the user interface of the application having the highest priority is on a display screen of the electronic device according to the acquired predetermined frame, determine a remaining area on the display screen, divide the remaining area into a plurality of sub-areas according to a predetermined division rule, adjust the positions of the user interfaces of remaining applications whose priority level is lower than the highest priority to the different sub-areas, and adjust a size of the predetermined frame of the user interfaces of the remaining applications to match a size of the corresponding sub-areas.

7. The electronic device as described in claim 6, wherein the processor is further configured to control the electronic device to enter an automatic adjusting mode in response to a user operation, and acquire the applications running in the electronic device real time, and acquire the priority of each acquired application when the electronic device is in the automatic adjusting mode.

8. The electronic device as described in claim 6, wherein each predetermined frame has a unique pixel value for identification, the processor is configured to compare the pixel value of the acquired predetermined frame with the pixel values of the predetermined frames of the user interfaces displayed on the display screen, and determine an area whose pixel value is consistent with the pixel value of the acquired predetermined frame, as the first area.

9. The electronic device as described in claim 6, wherein the processor is further configured to randomly assign the positions of the user interfaces of the remaining applications to the different sub-areas when size of the sub-area are same.

10. The electronic device as described in claim 6, wherein the processor is further configured to assign the positions of the user interfaces of the remaining applications to the different sub-areas according to the priority level of the remaining applications when size of the sub-areas are different.

11. A method for adjusting a position of a user interface of applications running in an electronic device, each of the applications corresponding to a user interface and being assigned a priority, each user interface comprising a predetermined frame, the method comprising:
determining the applications running in the electronic device, and determining the priority of each determined application;
acquiring the predetermined frame of the user interface of the application whose priority is the highest;
determining a first area where the user interface of the running application having the highest priority is on a display screen of the electronic device according to the acquired predetermined frame;
determining a remaining area on the display screen, and dividing the remaining area into a plurality of sub-areas according to a predetermined division rule;
adjusting the positions of the user interfaces of remaining applications whose priority is lower than the highest priority level to the different sub-areas; and
adjusting a size of the predetermined frame of the user interfaces of the remaining applications to match a size of the corresponding sub-areas.

12. The method as described in claim 11, further comprising:
controlling the electronic device to enter an automatic adjusting mode in response to a user operation, and
acquiring the applications running in the electronic device real time, and acquiring the priority of each acquired application when the electronic device is in the automatic adjusting mode.

13. The method as described in claim 11, wherein each predetermined frame has a unique pixel value for identification, the method further comprises:
comparing the pixel value of the acquired predetermined frame with the pixel values of the predetermined frames of the user interfaces displayed on the display screen; and
determining an area whose pixel value is consistent with the pixel value of the acquired predetermined frame, as the first area.

14. The method as described in claim 11, further comprising:
randomly assigning the positions of the user interfaces of the remaining applications to the different sub-areas when size of the sub-area are same.

15. The method as described in claim 11, further comprising:
assigning the positions of the user interfaces of the remaining applications to the different sub-areas according to the priority level of the remaining applications when size of the sub-areas are different.
